(19) United States
(12) Patent Application Publication
(10) Pub. No.: US 2026/0019284 A1
(43) Pub. Date: Jan. 15, 2026

(54) REVOCATION DETERMINATION METHOD, CERTIFICATE-REVOCATION-LIST CREATION METHOD, NON-TRANSITORY COMPUTER-READABLE RECORDING MEDIUM, REVOCATION DETERMINATION SYSTEM, AND CERTIFICATE-REVOCATION-LIST CREATION SYSTEM

(71) Applicant: Panasonic Intellectual Property Management Co., Ltd., Osaka (JP)

(72) Inventors: Yasushi TAKAHASHI, Fukuoka (JP); Yuji UNAGAMI, Osaka (JP)

(73) Assignee: Panasonic Intellectual Property Management Co., Ltd., Osaka (JP)

(21) Appl. No.: 19/335,756

(22) Filed: Sep. 22, 2025

Related U.S. Application Data
(63) Continuation of application No. PCT/JP2024/004899, filed on Feb. 13, 2024.

(30) Foreign Application Priority Data
Mar. 29, 2023 (JP) 2023-053521

(51) Int. Cl. H04L 9/32

(52) U.S. Cl. CPC H04L 9/3268

(57) ABSTRACT

A revocation determination method involves acquiring an electronic certificate, acquiring a certificate revocation list including one or more invalid certificates that are revoked electronic certificate, and determining, based on a serial number and one or more condition information items, whether the acquired electronic certificate is valid or invalid, the serial number being included in the acquired certificate revocation list, the one or more condition information items being indicated in one or more extension regions included in the acquired certificate revocation list.

### CROSS REFERENCE TO RELATED APPLICATIONS

This is a continuation application of PCT International Application No. PCT/JP2024/004899 filed on Feb. 13, 2024, designating the United States of America, which is based on and claims priority of Japanese Patent Application No. 2023-053521 filed on Mar. 29, 2023. The entire disclosures of the above-identified applications, including the specifications, drawings and claims are incorporated herein by reference in their entirety.

### FIELD

The present disclosure relates to a revocation determination method, a certificate-revocation-list creation method, a non-transitory computer-readable recording medium, a revocation determination system, and a certificate-revocation-list creation system.

### BACKGROUND

Patent Literature 1 discloses an electronic certificate verification method. This method includes a step of acquiring an electronic certificate, a step of verifying the acquired electronic certificate, a step of acquiring attribute-certification-authority identification information from the electronic certificate, a step of accessing an attribute certification authority in accordance with the acquired attribute-certification-authority identification information to acquire an attribute certificate, and a step of verifying the acquired attribute certificate.

Patent Literature 2 discloses a certificate registration method. This method includes a receiving step of receiving a new electronic certificate from a communication terminal via a network, the new electronic certificate including registration command information indicated in an extension region, a determination step of determining whether the received new electronic certificate is valid or invalid, an extraction step of, when the new electronic certificate is determined as valid, extracting the registration command information indicated in the extension region of the newly input valid electronic certificate, and a registration step of registering the new valid electronic certificate in accordance with the extracted registration command information.

### CITATION LIST

### Patent Literature

PTL 1: Japanese Unexamined Patent Application Publication No. 2004-356842
PTL 2: Japanese Unexamined Patent Application Publication No. 2005-311817

### SUMMARY

### Technical Problem

The present disclosure provides a revocation determination method or the like that can readily improve flexibility in determining whether an electronic certificate is valid or invalid.

### Solution to Problem

A revocation determination method according to one aspect of the present disclosure includes acquiring an electronic certificate, acquiring a certificate revocation list including one or more invalid certificates that are revoked electronic certificates, and determining, based on a serial number and one or more condition information items, whether the electronic certificate acquired is valid or invalid, the serial number being included in the certificate revocation list acquired, the one or more condition information items being indicated in one or more extension regions included in the certificate revocation list acquired.

A non-transitory computer-readable recording medium according to one aspect of the present disclosure causes one or more processors to execute the revocation determination method described above.

A revocation determination system according to one aspect of the present disclosure includes a first acquirer, a second acquirer, and a determiner. The first acquirer acquires an electronic certificate. The second acquirer acquires a certificate revocation list including one or more invalid certificates that are revoked electronic certificates. The determiner determines, based on a serial number and one or more condition information items, whether the electronic certificate acquired by the first acquirer is valid or invalid, the serial number being included in the certificate revocation list acquired by the second acquirer, the one or more condition information items being indicated in one or more extension regions included in the certificate revocation list acquired by the second acquirer.

A certificate-revocation-list creation method according to one aspect of the present disclosure includes acquiring one or more serial numbers of one or more invalid certificates that are revoked electronic certificates, acquiring one or more condition information items that indicate conditions for revocation and correspond respectively to one or more extension regions included in a certificate revocation list including the one or more invalid certificates, and creating the certificate revocation list by describing the one or more serial numbers acquired respectively in one or more serial number regions included in the certificate revocation list and describing the one or more condition information items acquired respectively in the one or more extension regions included in the certificate revocation list.

A non-transitory computer-readable recording medium according to one aspect of the present disclosure causes one or more processors to execute the certificate-revocation-list creation method described above.

A certificate-revocation-list creation system according to one aspect of the present disclosure includes a third acquirer, a fourth acquirer, and a creation controller. The third acquirer acquires one or more serial numbers of one or more invalid certificates that are revoked electronic certificates. The fourth acquirer acquires one or more condition information items that indicate conditions for revocation and correspond respectively to one or more extension regions included in a certificate revocation list including the one or more invalid certificates. The creation controller creates the certificate revocation list by describing the one or more serial numbers acquired by the third acquirer respectively in one or more serial number regions included in the certificate revocation list and describing the one or more condition information items acquired by the fourth acquirer respectively in the one or more extension regions included in the certificate revocation list.

### Advantageous Effects

The present disclosure has an advantage of being capable of readily improving flexibility in determining whether an electronic certificate is valid or invalid.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a diagram for describing an overview of checking whether an electronic certificate is valid or invalid.

FIG. 2 is a diagram showing one example of an electronic certificate.

FIG. 3 is a diagram for describing an issue that may arise at the time of checking whether a multi-certificate is valid or invalid.

FIG. 4 is a diagram for describing an overview of a revocation determination method according to Embodiment 1.

FIG. 5 is a block diagram showing one example of an overall configuration including the revocation determination system according to Embodiment 1.

FIG. 6 is a block diagram showing one example of a functional configuration of a certificate revocation list (CRL) creation device according to Embodiment 1.

FIG. 7 is a block diagram showing one example of a functional configuration of a CRL provider device according to Embodiment 1.

FIG. 8 is a block diagram showing one example of a functional configuration of a revocation check device according to Embodiment 1.

FIG. 9 is a block diagram showing one example of a functional configuration of a certificate presentation device according to Embodiment 1.

FIG. 10 is a sequence diagram showing an example of operations of the overall configuration including the revocation determination system according to Embodiment 1.

FIG. 11 is a flowchart showing an example of operations of a revocation determination system according to a comparative example.

FIG. 12 is a flowchart showing an example of operations of the revocation determination system according to Embodiment 1.

FIG. 13 is a diagram showing one example of revocation rules defined in the revocation determination system according to Embodiment 1.

FIG. 14 is an explanatory diagram showing an example of determination made by the revocation determination system according to Embodiment 1.

FIG. 15 is a block diagram showing one example of an overall configuration including a revocation determination system according to Embodiment 2.

FIG. 16 is a block diagram showing one example of a functional configuration of an online certificate status protocol (OCSP) response device according to Embodiment 2.

FIG. 17 is a block diagram showing one example of a functional configuration of a revocation check device according to Embodiment 2.

FIG. 18 is a sequence diagram showing an example of operations of the overall configuration including the revocation determination system according to Embodiment 2.

FIG. 19 is a diagram showing one example of one or more extension regions included in a certificate revocation list.

### DESCRIPTION OF EMBODIMENTS

### Underlying Knowledge Forming Basis of the Present Disclosure

Electronic certificates (public key certificates) that are certificates for binding a public key to identification information about the owner of the public key are used for communication on networks such as the Internet. The electronic certificates are hereinafter also simply referred to as “certificates”. The certificates are issued by credentialling entities such as certification authorities (CA), but may be revoked within their terms of validity for various reasons such as private keys being leaked. Revoked electronic certificates (hereinafter also referred to as “invalid certificates”) are registered in a certificate revocation list (hereinafter also referred to as a “CRL”) issued by each credentialling entity. Thus, in the communication, a user who has received a certificate needs to check whether the certificate is valid or invalid, or in other words, whether the certificate is registered in the CRL, in order to verify the certificate.

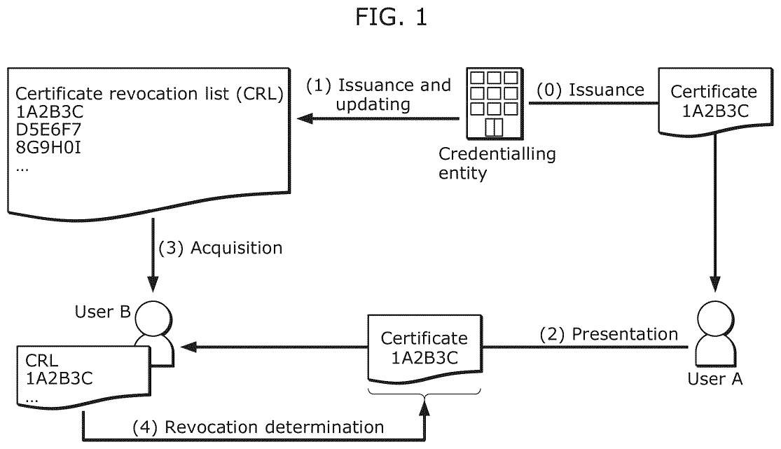

FIG. 1 is a diagram for describing an overview of checking whether an electronic certificate is valid or invalid. In the following description, unless otherwise specified, “user A” refers to an information terminal used by user A, and “user B” refers to an information terminal used by user B. The information terminals may, for example, terminals that include a processor and memory, such as personal computers, smartphones, or digitizing tablets.

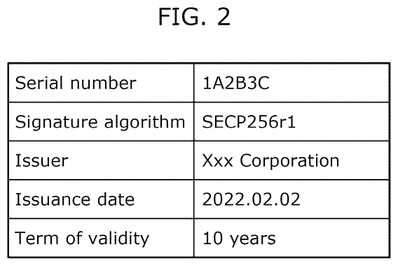

FIG. 2 is a diagram showing one example of an electronic certificate. As shown in FIG. 2, the electronic certificate contains information items that respectively indicate a serial number assigned to the electronic certificate, a signature algorithm used for a digital signature, an issuer of the electronic certificate, an issuance date of the electronic certificate, and the term of validity of the electronic certificate.

In FIG. 1, firstly, a credentialling entity issues a certificate whose serial number is “1A2B3C” to user A (see (0) in FIG. 1). After issuance of the certificate, if the certificate is revoked for some reasons, the credentialling entity updates a CRL by registering this certificate in the CRL (see (1) in FIG. 1). Here, serial number “1A2B3C” is newly registered in the CRL.

Thereafter, when communication is carried out between users A and B, user A transmits and presents the certificate whose serial number is “1A2B3C” to user B (see (2) in FIG. 1). User B who has received the certificate acquires the CRL (see (3) in FIG. 1) and determines whether the certificate is valid or invalid, by checking whether the serial number of the received certificate is included in the CRL (see (4) in FIG. 1). In the example shown in FIG. 1, since serial number “1A2B3C” of the certificate is registered in the CRL, user B determines that the certificate received from user A is invalid.

Meanwhile, with the advent of quantum computers in recent years, the development of quantum computers is being carried out actively. On the other hand, with the expansion of the scales of quantum computers, currently cryptography systems (hereinafter, also referred to as “classical cryptography systems”) are known to be compromised theoretically. In view of such circumstances, post-quantum cryptography systems (hereinafter also referred to as “PQC systems”) that are new cryptography systems capable of withstanding computing performance of large-scale quantum computers have been proposed, and studies are being conducted on the transition from certificates using the classical cryptography systems (hereinafter, also referred to as “classical certificates”) to certificates using the PQC systems (hereinafter also referred to as “PQC certificates”). Examples of the classical cryptography systems being used include RSA cryptography and elliptical curve cryptography. Examples of the PQC systems being used include CRYSTALS-Dilithium.

During the transition from the classical cryptography systems to the PQC systems, PQC-compliant equipment and non-PQC-compliant equipment coexist, and therefore compatible certificates that can be used in any equipment are needed and are being developed. As such certificates, for example, highly compatible certificates having characteristics described below (hereinafter, also referred to as “multi-certificates”) are being developed. The multi-certificates have the characteristic that they each include a pair of classical and PQC certificates. The multi-certificates also have the characteristic that their classical and PQC certificates have a common serial number.

However, since the classical and PQC certificates of each multi-certificate have a common serial number, a situation may arise in which the PQC certificate may be downgraded to the classical certificate at the time when the PQC certificate is supposed to be used. Here, downgrading may occur when a user uses the classical certificate mistakenly at the time when the PQC certificate is supposed to be used preferentially. Downgrading may also occur when a malicious third party launches an attack to replace the PQC certificate to the classical certificate. In view of this, it is conceivable to revoke a downgraded certificate, but the following issues will arise in the case of using an existing CRL.

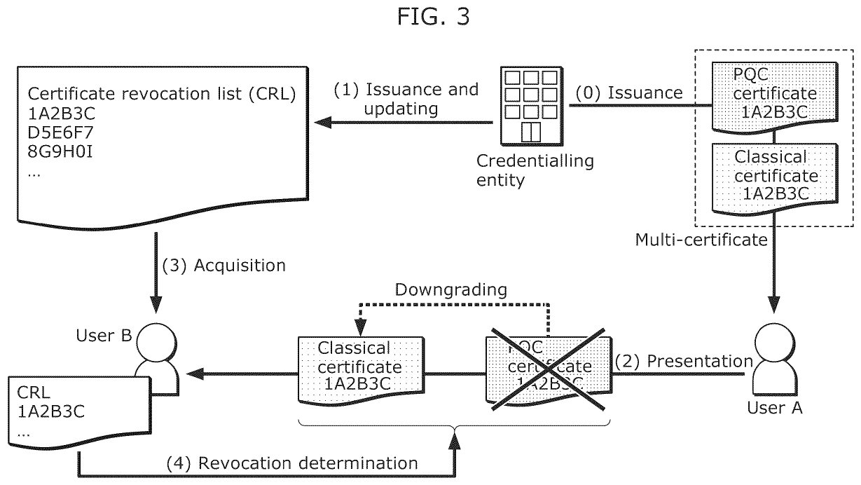

FIG. 3 is a diagram for describing an issue that may arise at the time of checking whether a multi-certificate is valid or invalid. In FIG. 3, firstly, a credentialling entity issues a multi-certificate whose serial number is “1A2B3C” to user A (see (0) in FIG. 3). After issuance of the multi-certificate, in order to revoke the classical certificate included in the multi-certificate, the credentialling entity updates the CRL by registering serial number “1A2B3C” of the multi-certificate in the CRL (see (1) in FIG. 3).

Thereafter, when communication is carried out between users A and B, a case is assumed in which user A attempts to transmit and present the PQC certificate whose serial number is “1A2B3C” to user B, but the classical certificate is presented to user B due to downgrading of the PQC certificate (see (2) in FIG. 3). User B who has received this certificate acquires the CRL (see (3) in FIG. 3) and determines whether the certificate is valid or invalid, by checking whether the serial number of the received certificate is included in the CRL (see (4) in FIG. 3). In the example shown in FIG. 3, since serial number “1A2B3C” of the certificate is registered in the CRL, user B determines that the certificate received from user A is invalid.

However, in the above-described CRL, only the serial number is referenced to identify the certificate. Thus, even if the user attempts to revoke only the classical certificate, both of the classical certificate and the PQC certificate will be revoked. In the example shown in FIG. 3, the whole multi-certificate whose serial number is “1A2B3C” will be revoked. In this way, the use of the serial number to determine whether the electronic certificate is valid or invalid involves an issue of lack of flexibility in determining whether the electronic certificate is valid or invalid.

It is an object of the present disclosure to provide a revocation determination method or the like that can readily improve flexibility in determining whether an electronic certificate is valid or invalid, by using one or more extension regions included in a CRL.

More specifically, a revocation determination method according to a first aspect of the present disclosure includes acquiring an electronic certificate, acquiring a certificate revocation list including one or more invalid certificates that are revoked electronic certificates, and determining, based on a serial number and one or more condition information items, whether the electronic certificate acquired is valid or invalid, the serial number being included in the certificate revocation list acquired, the one or more condition information items being indicated in one or more extension regions included in the certificate revocation list acquired.

This method has an advantage in that the electronic certificate is identified by referencing the one or more condition information items indicated in the one or more extension regions, instead of referencing only the serial number included in the certificate revocation list. Thus, for example, even in the case where a plurality of electronic certificates have a common serial number, it is possible to readily improve flexibility in determining whether the electronic certificate is valid or invalid, such as to revoke only one of the electronic certificates.

For example, a revocation determination method according to a second aspect of the present disclosure is the revocation determination method according to the first aspect, in which the one or more extension regions contain information indicating a signature algorithm targeted for revocation, and the electronic certificate is determined as invalid when the serial number of the electronic certificate is included in the certificate revocation list and a signature algorithm of the electronic certificate matches the signature algorithm targeted for revocation.

This method has an advantage in that, for example, even in the case where a plurality of electronic certificates have a common serial number, it is possible to distinguish each electronic certificate by referencing the signature algorithm and determine whether the electronic certificate is valid or invalid.

For example, a revocation determination method according to a third aspect of the present disclosure is the revocation determination method according to the first or second aspect, in which the one or more extension regions contain information indicating a reason for revocation, and the electronic certificate is determined as invalid when the serial number of the electronic certificate is included in the certificate revocation list and the electronic certificate corresponds to the reason for revocation.

This method has an advantage in that, for example, even in the case where a plurality of electronic certificates have a common serial number, it is possible to distinguish each electronic certificate by referencing the reason for revocation and determine whether the electronic certificate is valid or invalid.

For example, a revocation determination method according to a fourth aspect of the present disclosure is the revocation determination method according to the any one of the first to third aspects, in which the electronic certificate is a certificate using a classical cryptography system or a certificate using a post-quantum cryptography system.

This method has an advantage in that, even in the case where there is a multi-certificate that includes a certificate using a classical cryptography system and a certificate using a post-quantum cryptography system, both of the certificates having a common serial number, it is possible to revoke only either one of the certificate using the classical cryptography system and the certificate using the post-quantum cryptography system.

For example, a revocation determination method according to a fifth aspect of the present disclosure is the revocation determination method according to the fourth aspect, in which whether a device that checks whether the electronic certificate is valid or invalid supports the post-quantum cryptography system is further referenced to determine whether the electronic certificate is valid or invalid.

This method has an advantage in that, since whether the electronic certificate is valid or invalid is determined depending on the type of the device, it is possible to more readily improve flexibility in determining whether the electronic certificate is valid or invalid.

For example, a program according to a sixth aspect of the present disclosure causes one or more processors to execute the revocation determination method according to any one of the first to fifth aspects.

This program has an advantage of achieving the same effects as those achieved by the revocation determination method described above.

For example, a revocation determination system according to a seventh aspect of the present disclosure includes a first acquirer, a second acquirer, and a determiner. The first acquirer acquires an electronic certificate. The second acquirer acquires a certificate revocation list including one or more invalid certificates that are revoked electronic certificates. The determiner determines, based on a serial number and one or more condition information items, whether the electronic certificate acquired by the first acquirer is valid or invalid, the serial number being included in the certificate revocation list acquired by the second acquirer, the one or more condition information items being indicated in one or more extension regions included in the certificate revocation list acquired by the second acquirer.

This system has an advantage of achieving the same effects as those achieved by the revocation determination method described above.

For example, a certificate-revocation-list creation method according to an eighth aspect of the present disclosure includes acquiring one or more serial numbers of one or more invalid certificates that are revoked electronic certificates, acquiring one or more condition information items that indicate conditions for revocation and correspond respectively to one or more extension regions included in a certificate revocation list including the one or more invalid certificates, and creating the certificate revocation list by describing the one or more serial numbers acquired respectively in one or more serial number regions included in the certificate revocation list and describing the one or more condition information items acquired respectively in the one or more extension regions included in the certificate revocation list.

This method has an advantage in that the electronic certificate can be identified by referencing the one or more condition information items indicated in the one or more extension regions, instead of referencing only the serial number included in the certificate revocation list, at the time of determining whether the certificate is valid or invalid. Thus, for example, even in the case where a plurality of electronic certificates have a common serial number, it is possible to more readily improve flexibility in determining whether the electronic certificate is valid or invalid, such as to revoke only one of the electronic certificates.

For example, a program according to a ninth aspect of the present disclosure causes one or more processors to execute the certificate-revocation-list creation method according to the eighth aspect.

This program has an advantage of achieving the same effects as those achieved by the certificate-revocation-list creation method described above.

For example, a certificate-revocation-list creation system according to a tenth aspect of the present disclosure includes a third acquirer, a fourth acquirer, and a creation controller. The third acquirer acquires one or more serial numbers of one or more invalid certificates that are revoked electronic certificates. The fourth acquirer acquires one or more condition information items that indicate conditions for revocation and correspond respectively to one or more extension regions included in a certificate revocation list including the one or more invalid certificates. The creation controller creates the certificate revocation list by describing the one or more serial numbers acquired by the third acquirer respectively in one or more serial number regions included in the certificate revocation list and describing the one or more condition information items acquired by the fourth acquirer respectively in the one or more extension regions included in the certificate revocation list.

This system has an advantage of achieving the same effects as those achieved by the certificate-revocation-list creation method described above.

These general and specific aspects may be realized as systems, devices, methods, integrated circuits, computer programs, or non-transitory recording media such as computer-readable CD-ROMs, or may be realized as any combination of a system, a device, a method, an integrated circuit, a computer program, and a recording medium.

Hereinafter, embodiments are described in detail with reference to the drawings. Each embodiment described below shows a general or specific example. Numerical values, shapes, materials, constituent elements, arrangement positions and connection form of constituent elements, steps, a sequence of steps, and so on shown in the following embodiments are merely examples and do not intend to limit the scope of the present disclosure. Among the constituent elements described in the following embodiments, those that are not recited in any of the independent claims are described as optional constituent elements. Note that each drawing is a schematic diagram and does not necessarily provide precise depiction. Constituent elements that are substantially the same are given the same reference sign throughout the drawings, and redundant descriptions thereof may be omitted or simplified.

### Embodiment 1

### 1. Overview

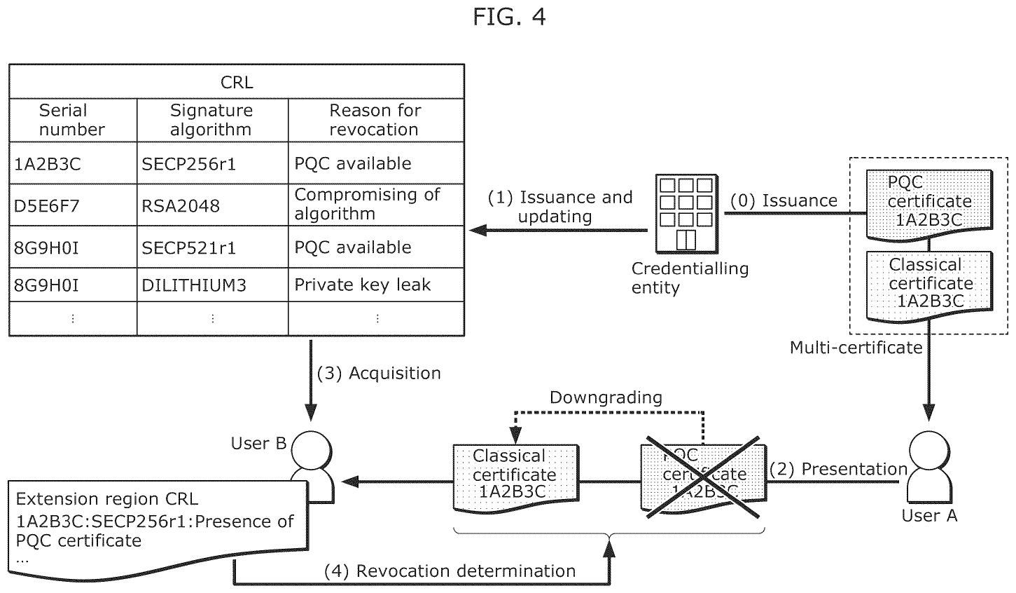

Firstly, an overview of a revocation determination system (revocation determination method) according to Embodiment 1 will be described. In Embodiment 1, an electronic certificate for which the revocation determination system determines whether the certificate is valid or invalid is a certificate using a classical cryptography system or a certificate using a post-quantum cryptography system (PQC system). FIG. 4 is a diagram for describing an overview of the revocation determination method according to Embodiment 1. In FIG. 4, the revocation determination system is an information terminal used by user B.

In FIG. 4, firstly, a credentialling entity issues a multi-certificate whose serial number is “1A2B3C” to user A (see (0) in FIG. 4). After issuance of the multi-certificate, in order to revoke a classical certificate included in the multi-certificate, the credentialling entity updates a CRL by registering serial number “1A2B3C” of the multi-certificate in the CRL and creating the CRL such that the CRL includes one or more non-critical extension regions (see (1) in FIG. 4). In the example shown in FIG. 4, among the one or more extension regions that correspond to serial number “1A2B3C”, an extension region indicating “Signature algorithm” describes “SECP256r1”, and an extension region indicating “Reason for revocation” describes “PQC available”. “SECP256r1” refers to one signature algorithm using elliptic curve cryptography. “PQC available” indicates the reason that the classical certificate is revoked due to the presence of the PQC certificate.

Thereafter, when communication is carried out between users A and B, a case is assumed in which user A attempts to transmit and present the PQC certificate whose serial number is “1A2B3C” to user B, but the classical certificate is presented to user B due to downgrading of the PQC certificate (see (2) in FIG. 4). User B who has received this certificate acquires the CRL (see (3) in FIG. 4) and determines whether the certificate is valid or invalid, by checking whether the serial number of the received certificate is included in the CRL and whether the certificate satisfies one or more condition information items indicated in the one or more extension regions (see (4) in FIG. 4). In the example shown in FIG. 4, since serial number “1A2B3C” of the certificate is registered in the CRL and the certificate satisfies the conditions described in the one or more extension regions, user B determines that the classical certificate received from user A is invalid.

As described above, in the CRL shown in FIG. 4, not only the serial number is referenced, but also the one or more condition information items indicated in the one or more extension regions are referenced to identify the certificate. Thus, it is possible to revoke only the classical certificate and to prevent both of the classical certificate and the PQC certificate from being revoked. That is, the revocation determination system (revocation determination method) according to Embodiment 1 has an advantage of readily improving flexibility in determining whether the electronic certificate is valid or invalid, such as to revoke only the classical certificate, by using the one or more extension regions included in the CRL.

### 2. Configuration

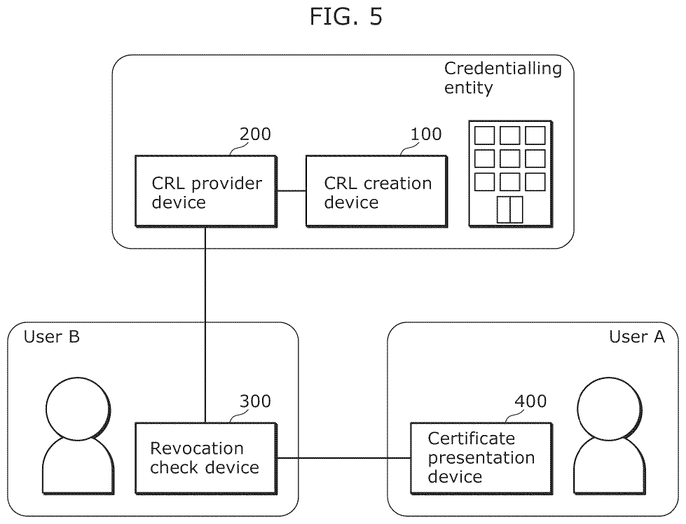

Next, an overall configuration of the revocation determination system according to Embodiment 1 will be described. FIG. 5 is a block diagram showing one example of the overall configuration including the revocation determination system according to Embodiment 1. As shown in FIG. 5, Embodiment 1 is described assuming that communication is carried out between certificate presentation device 400 managed and operated by user A and revocation check device 300 managed and operated by user B. In Embodiment 1, revocation check device 300 corresponds to the revocation determination system. Revocation check device 300 and certificate presentation device 400 are realized by, for example, information terminals such as personal computers, smartphones, or digitizing tablets.

A credentialling entity manages and operates CRL creation device 100 and CRL presentation device 200. In Embodiment 1, CRL creation device 100 corresponds to a certificate-revocation-list creation system which will be described later. CRL creation device 100 and CRL presentation device 200 are realized by, for example, server devices. Alternatively, CRL creation device 100 may be configured integrally with CRL presentation device 200, or may be included in CRL presentation device 200 and realized as a part of the functions of CRL presentation device 200.

In Embodiment 1, CRL creation device 100, CRL presentation device 200, revocation check device 300, and certificate presentation device 400 are configured to be capable of communication with one another via a network such as the Internet.

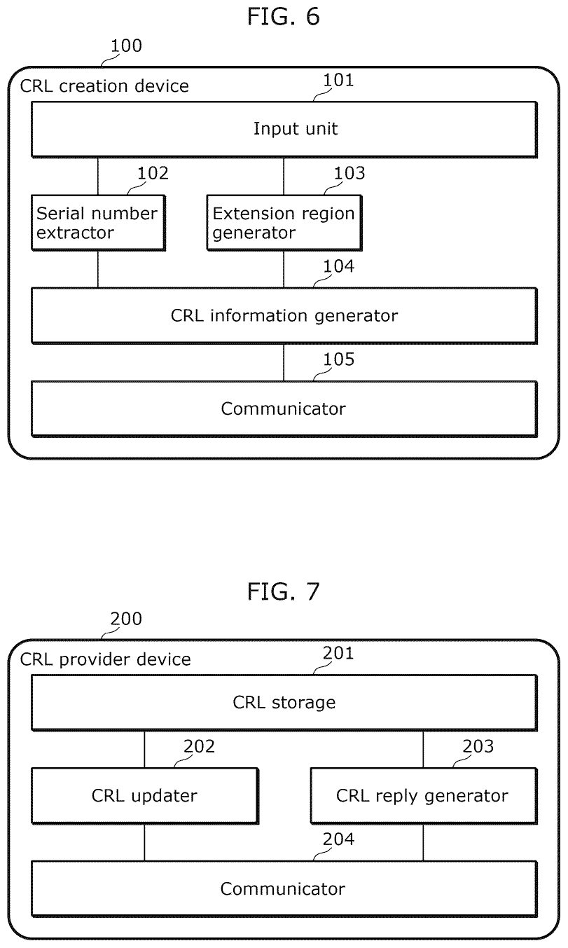

FIG. 6 is a block diagram showing one example of a functional configuration of CRL creation device 100 according to Embodiment 1. CRL creation device 100 analyzes information about an invalid certificate input by the credentialling entity and generates CRL information. The CRL information includes, in addition to a newly created CRL, CRL update information for use in updating the already existing CRL. The CRL update information may be the updated CRL, or may be information about a difference between the updated CRL and the existing CRL. CRL creation device 100 transmits the generated CRL information to CRL presentation device 200.

CRL creation device 100 includes a processor and memory and realizes its function by the processor executing a program stored in the memory. As shown in FIG. 6, CRL creation device 100 includes input unit 101, serial number extractor 102, extension region generator 103, CRL information generator 104, and communicator 105.

Input unit 101 accepts input of information about an invalid certificate selected by a credentialling entity. The information about the invalid certificate includes the serial number of the invalid certificate. The information about the invalid certificate may further include other information such as the issuer of the certificate, the uses of the certificate, the signature algorithm used for the certificate, or the reason for revocation of the certificate.

Serial number extractor 102 extracts one or more serial numbers from information about one or more invalid certificates that are input to input unit 101. Serial number extractor 102 corresponds to a third acquirer in the certificate-revocation-list creation system. Serial number extractor 102 (third acquirer) acquires one or more serial numbers of one or more invalid certificates that are revoked electronic certificates.

Extension region generator 103 extracts one or more condition information items from the information about the one or more invalid certificates that are input to input unit 101, the one or more condition information items being described respectively in one or more extension regions included in the CRL information generated by CRL information generator 104. The condition information items are information items that indicate conditions for revocation. Extension region generator 103 corresponds to a fourth acquirer in the certificate-revocation-list creation system. Extension region generator 103 (fourth acquirer) acquires one or more condition information items that indicate the conditions for revocation and correspond respectively to the one or more extension regions included in the certificate revocation list (CRL) including one or more invalid certificates. Note that if the condition information items are not included in the information about the invalid certificates that are input to input unit 101, NULL is extracted. In Embodiment 1, extension region generator 103 extracts information indicating a signature algorithm as the condition information item described in a first extension region and extracts information indicating the reason for revocation as the condition information item described in a second extension region.

CRL information generator 104 describes each serial number extracted by serial-number extractor 102 in a serial number region that describes the serial number in the CRL information. CRL information generator 104 also describes the information extracted by extension region generator 103 in a corresponding extension region. CRL information generator 104 corresponds to a creation controller in the certificate-revocation-list creation system. CRL information generator 104 (creation controller) creates the certificate revocation list (CRL) by describing the one or more serial numbers acquired by serial-number extractor 102 (third acquirer) respectively in one or more serial number regions included in the certificate revocation list and by describing the one or more condition information items acquired by extension region generator 103 (fourth acquirer) respectively in the one or more extension regions included in the certificate revocation list.

In Embodiment 1, CRL information generator 104 describes information indicating the signature algorithm extracted by extension region generator 103 in the first extension region and describes information indicating the reason for revocation in the second extension region. In this way, CRL information generator 104 generates the CRL information that contains the serial numbers of the invalid certificates and the information item described in each of the one or more extension regions that are associated with the serial numbers.

Communicator 105 transmits the CRL information generated by CRL information generator 104 to CRL presentation device 200.

FIG. 7 is a block diagram showing one example of a functional configuration of CRL presentation device 200 according to Embodiment 1. CRL presentation device 200 stores the CRL information generated by CRL creation device 100. Upon receiving a CRL request from revocation check device 300, CRL presentation device 200 transmits a CRL reply that includes the CRL information to revocation check device 300.

CRL presentation device 200 includes a processor and memory and realizes its function by the processor executing a program stored in the memory. As shown in FIG. 7, CRL presentation device 200 includes CRL storage 201, CRL updater 202, CRL replay generator 203, and communicator 204.

CRL storage 201 stores the CRL information received from CRL creation device 100 by communicator 204. CRL storage 201 also stores CRL information updated by CRL updater 202. As the CRL information, CRL storage 201 may store the CRL, or may store the CRL update information.

When communicator 204 has received the CRL update information from CRL creation device 100, CRL updater 202 stores the CRL update information as the CRL information in CRL storage 201. Alternatively, CRL updater 202 may read out the CRL from CRL storage 201, update part or the whole of the readout CRL in accordance with the CRL update information, and store the updated CRL as the CRL information in CRL storage 201.

When communicator 204 has received a CRL request from revocation check device 300, CRL replay generator 203 reads out the CRL information from CRL storage 201 and generates a CRL reply that includes the readout CRL information.

Communicator 204 receives the CRL information from CRL creation device 100. Communicator 204 also receives a CRL request from revocation check device 300. Communicator 204 further transmits a CRL reply generated by CRL replay generator 203 to revocation check device 300.

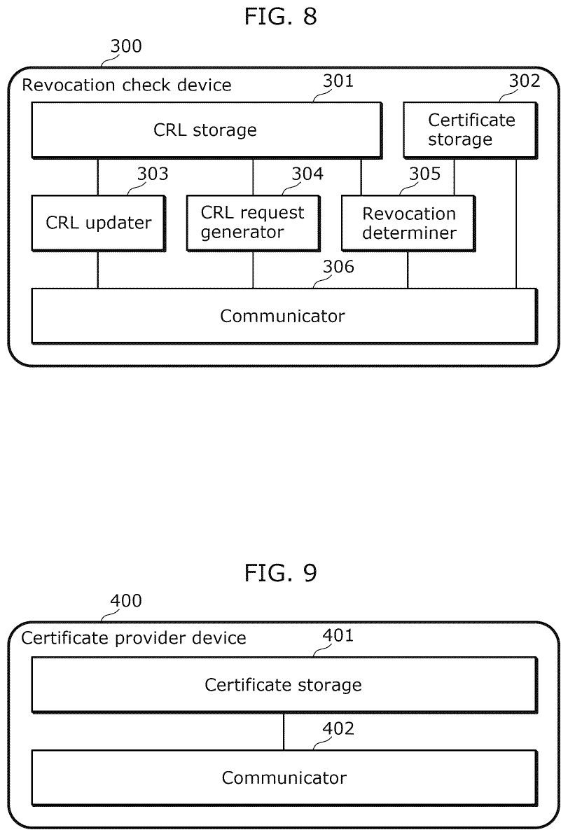

FIG. 8 is a block diagram showing one example of a functional configuration of revocation check device 300 according to Embodiment 1. Upon receiving a certificate from certificate presentation device 400, revocation check device 300 stores the certificate. Then, revocation check device 300 generates a CRL request and transmits the generated CRL request to CRL presentation device 200. The CRL request may include, for example, information about the CRL stored in revocation check device 300, information about revocation check device 300, information about the certificate, and information about the uses of the certificate.

Revocation check device 300 includes a processor and memory and realizes its function by the processor executing a program stored in the memory. As shown in FIG. 8, revocation check device 300 includes CRL storage 301, certificate storage 302, CRL updater 303, CRL request generator 304, revocation determiner 305, and communicator 306.

CRL storage 301 stores the CRL. When the CRL is updated by CRL updater 303, CRL storage 301 also stores the updated CRL.

Certificate storage 302 stores the certificate received from certificate presentation device 400 by communicator 306.

When communicator 306 has received a CRL reply from CRL presentation device 200, CRL updater 303 stores the updated CRL included in the CRL reply in CRL storage 301. In the case where the CRL reply includes the CRL update information, CRL updater 303 may read out the CRL from CRL storage 301, update part or the whole of the readout CRL in accordance with the CRL update information, and store the updated CRL in CRL storage 301.

CRL request generator 304 generates a CRL request when revocation determiner 305 performs revocation determination processing for determining whether the certificate is valid or invalid.

When communicator 306 has received a certificate from certificate presentation device 400, revocation determiner 305 performs revocation determination processing for determining whether the received certificate is valid or invalid. Firstly, revocation determiner 305 requests the latest CRL from CRL presentation device 200 and updates the CRL stored in CRL storage 301 to the latest CRL. Note that if the CRL included in the CRL reply is the same as the CRL already stored in CRL storage 301, the CRL does not need to be updated. Then, revocation determiner 305 determines whether the received certificate is valid or invalid, by using the latest CRL and revocation rules stored in advance. Revocation determiner 305 corresponds to a determiner in the revocation determination system. Revocation determiner 305 (determiner) determines, based on the serial number and one or more condition information items, whether the electronic certificate acquired by communicator 306 (a first acquirer which will be described later) is valid or invalid, the serial number being included in the certificate revocation list (CRL) acquired by communicator 306 (a second acquirer which will be described later), the one or more condition information items being indicated in one or more extension regions included in the certificate revocation list acquired by communicator 306. Details on the revocation determination processing will be described later in 3-2. Revocation Determination Processing.

Communicator 306 receives a certificate from certificate presentation device 400. Communicator 306 corresponds to the first acquirer that acquires an electronic certificate in the revocation determination system. Communicator 306 also transmits a CRL request generated by CRL request generator 304 to CRL presentation device 200. Communicator 306 also receives a CRL reply from CRL presentation device 200. Here, the CRL reply includes the CRL information as described above. Communicator 306 corresponds to the second acquirer that acquires a certificate revocation list (CRL) in the revocation determination system, the CRL including one or more invalid certificates that are one or more revoked electronic certificates.

FIG. 9 is a block diagram showing one example of a functional configuration of certificate presentation device 400 according to Embodiment 1. When the user communicates with another user, certificate presentation device 400 transmits and presents a certificate to the other user.

Certificate presentation device 400 includes a processor and memory and achieves its function by the processor executing a program stored in the memory. As shown in FIG. 9, certificate presentation device 400 includes certificate storage 401 and communicator 402.

Upon receiving a certificate issued by a credentialling entity, certificate storage 401 stores the certificate.

Communicator 402 receives a certificate from a credentialling entity. When the user communicates with another user, communicator 402 transmits a certificate stored in certificate storage 401 to the information terminal (here, revocation check device 300) of the other user.

### 3. Operations

### 3-1. Basic Operations

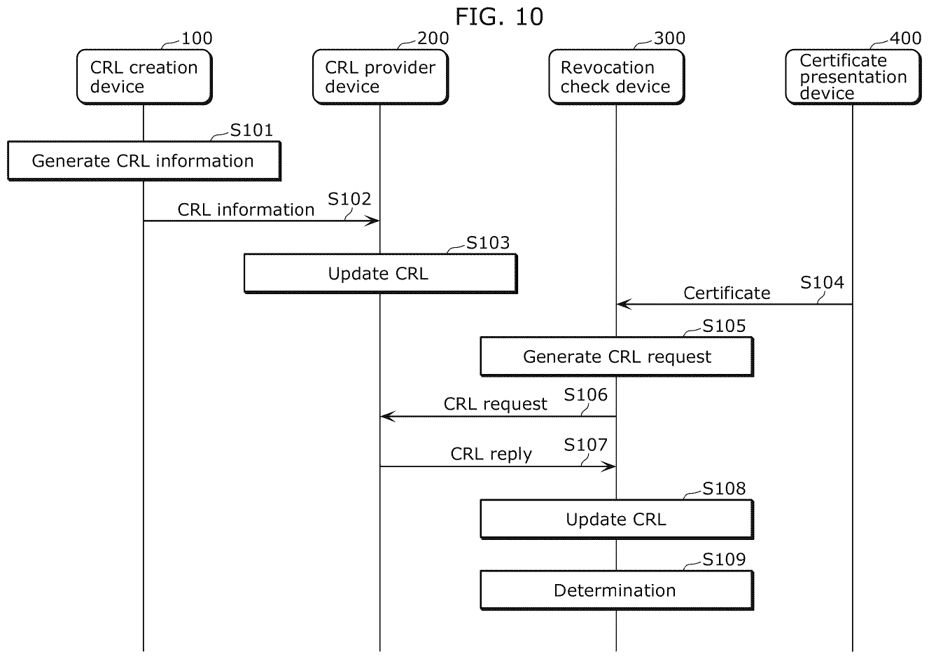

An example of operations of the overall configuration including the revocation determination system according to Embodiment 1 will be described hereinafter. FIG. 10 is a sequence diagram showing the example of operations of the overall configuration including the revocation determination system according to Embodiment 1. The following description is given assuming that a credentialling entity has issued a certificate to user A, and certificate presentation device 400 has stored therein the certificate. In the following description, it is also assumed that a CRL has been updated after insurance of this certificate.

Firstly, CRL creation device 100 analyzes information about the invalid certificate input by the credentialling entity and generates CRL information (S101). Then, CRL creation device 100 transmits the generated CRL information to CRL presentation device 200 (S102). Upon receiving the CRL information, CRL presentation device 200 updates the stored CRL (S103). Accordingly, the latest CRL is stored in CRL presentation device 200.

Next, when user A communicates with another user (here, user B), the stored certificate is transmitted to the information terminal (here, revocation check device 300) of the other user (S104). Upon receiving the certificate, revocation check device 300 generates a CRL request (S105). Then, revocation check device 300 transmits the generated CRL request to CRL presentation device 200 (S106). Upon receiving the CRL request, CRL presentation device 200 generates a CRL reply and transmits the generated CRL reply to revocation check device 300 (S107).

Next, upon receiving the CRL reply, revocation check device 300 updates the stored CRL with reference to the received CRL reply (S108). In this way, the latest CRL is stored in revocation check device 300. Then, by using the latest CRL, revocation check device 300 determines whether the received certificate is valid or invalid (S109).

### 3-2. Revocation Determination Processing

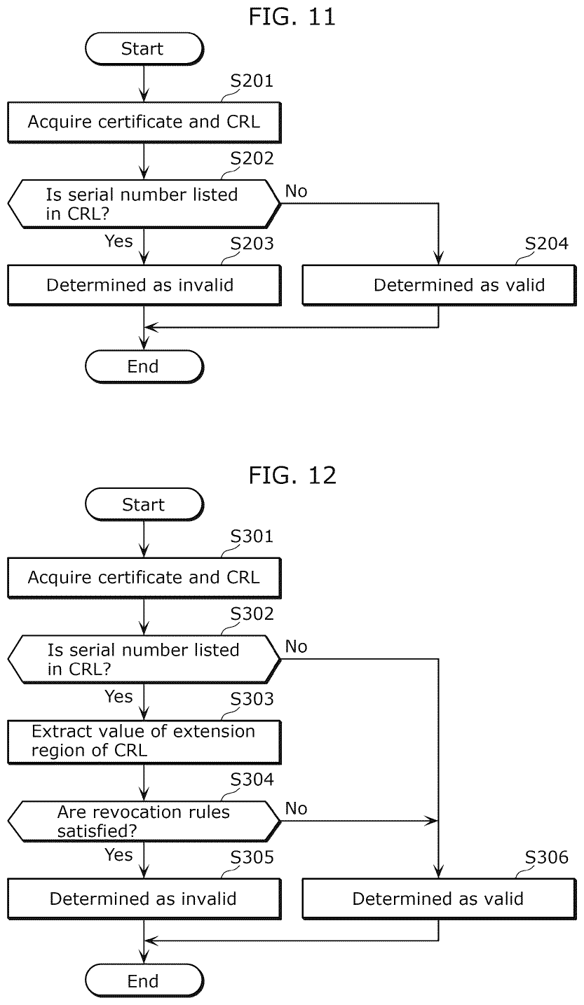

Here, the revocation determination processing for determining whether the received certificate is valid or invalid will be described in detail. Firstly, revocation determination processing performed in a revocation determination system according to a comparative example will be described with reference to FIG. 11. The revocation determination system according to the comparative example corresponds to a revocation check device that does not support extension regions in a CRL. Here, the phrase “a revocation check device that does not support extension regions included in a CRL” means that the revocation check device is incapable of recognizing the extension regions included in the CRL.

Note that whether the revocation check device supports extension regions included in a CRL depends on the performance or the like of the revocation check device. For example, a revocation check device that supports PQC cryptography systems is capable of updating firmware and is sufficient in performance, so that this revocation check device basically supports extension regions included in a CRL. On the other hand, a revocation check device that does not support PQC cryptography systems is often incapable of updating firmware or is often insufficient in performance, so that this revocation check device basically does not support extension regions included in a CRL.

FIG. 11 is a flowchart showing an example of operations of the revocation determination system (revocation check device) according to the comparative example. Firstly, the revocation check device acquires a certificate and a CRL (S201). Then, if the serial number of the acquired certificate is included in the CRL (Yes in S202), the revocation check device determines that the certificate is invalid (S203). On the other hand, if the serial number of the acquired certificate is not included in the CRL (No in S202), the revocation check device determines that the certificate is valid (S204). As described above, the revocation determination system according to the comparative example references only the serial number of the certificate to determine whether the certificate is valid or invalid.

Next, the revocation determination processing performed in the revocation determination system according to Embodiment 1 will be described with reference to FIG. 12. As already described, the revocation determination system according to Embodiment 1 corresponds to revocation check device 300. Revocation check device 300 supports extension regions included in a CRL. FIG. 12 is a flowchart showing an example of operations of the revocation determination system (revocation check device 300) according to Embodiment 1.

Firstly, revocation check device 300 acquires a certificate and a CRL (S301). Then, if the serial number of the acquired certificate is included in the CRL (Yes in S302), revocation check device 300 extracts the value(s) of one or more extension regions that correspond to this serial number included in the CRL (S303). Specifically, when the serial number is I={k1, . . . , kn}, revocation check device 300 extracts value V1={Vk1, 1, . . . , Vkn, 1} described in the first extension region, . . . , and value VN={Vk1, N, . . . , Vkn, N} described in the N-th extension region. In Embodiment 1, value V1 described in the first extension region and value V2={Vk1, 2, . . . , Vkn, 2} described in the second extension region are extracted.

Then, by using the extracted value(s) of the one or more extension regions, revocation check device 300 determines whether the certificate conforms to revocation rules. When the certificate conforms to the revocation rules (Yes in S304), the certificate is determined as invalid (S305). On the other hand, when the certificate does not conform to the revocation rules (No in S305) and the serial number of the certificate is not included in the CRL (No in S302), revocation check device 300 determines the certificate as valid.

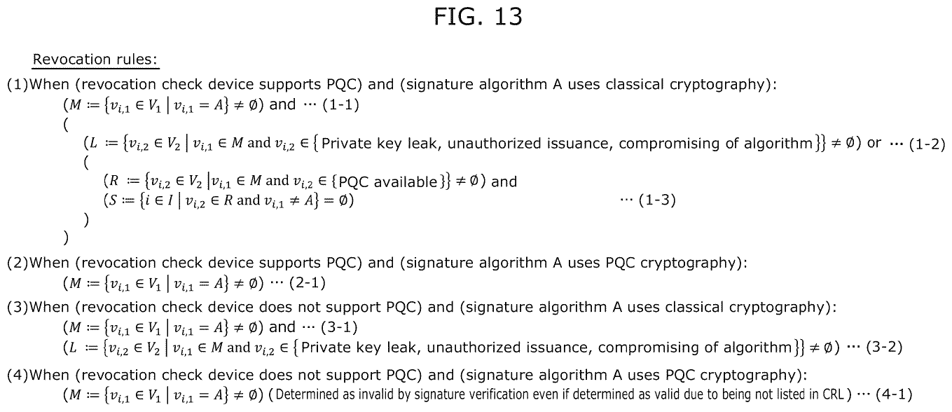

FIG. 13 is a diagram showing one example of the revocation rules used in the revocation determination system (revocation check device 300) according to Embodiment 1. In FIG. 13, “A” in logical expressions represents the signature algorithm of a certificate. The revocation rules are roughly divided into four cases: (1) the case where revocation check device 300 supports PQC systems and the signature algorithm of the certificate is a classical cryptography system; (2) the case where revocation check device 300 supports PQC systems and the signature algorithm of the certificate uses a PQC system; (3) the case where revocation check device 300 does not support PQC systems and the signature algorithm of the certificate is a classical cryptography system; and (4) the case where revocation check device 300 does not support PQC systems and the signature algorithm of the certificate is a PQC system. In this way, the revocation determination system (revocation determination method) according to Embodiment 1 determines whether the electronic certificate is valid or invalid, by further referencing whether the device for checking whether the electronic certificate is valid or invalid (revocation check device 300) supports the post-quantum cryptography system (PQC system).

In case (1), if the signature algorithm of the certificate matches the signature algorithm indicated by the value described in the first extension region (see (1-1) in FIG. 13) and the reason for revocation indicated by the value described in the second extension region is one of “private key leak”, “unauthorized issuance”, and “compromising of algorithm” (see (1-2) in FIG. 13), revocation check device 300 determines that the certificate conforms to the revocation rules. Revocation check device 300 also determines that the certificate conforms to the revocation rules, if the signature algorithm of the certificate matches the signature algorithm indicated by the value described in the first extension region (see (1-1) in FIG. 13), the reason for revocation indicated by the value described in the second extension region is the “PQC available”, and the signature algorithm of the certificate is not the PQC system (see (1-3) in FIG. 13). If otherwise, revocation check device 300 determines that the certificate does not conform to the revocation rules.

In case (2), if the signature algorithm of the certificate matches the signature algorithm indicated by the value described in the first extension region (see (2-1) in FIG. 13), revocation check device 300 determines that the certificate conforms to the revocation rules. If otherwise, revocation check device 300 determines that the certificate does not conform to the revocation rules.

In case (3), if the signature algorithm of the certificate matches the signature algorithm indicated by the value described in the first extension region (see (3-1) in FIG. 13) and the reason for revocation indicated by the value described in the second extension region is one of “private key leak”, unauthorized issuance”, and “compromising of algorithm” (see (3-2) in FIG. 13), revocation check device 300 determines that the certificate conforms to the revocation rules. If otherwise, revocation check device 300 determines that the certificate does not conform to the revocation rules.

In case (4), if the signature algorithm of the certificate matches the signature algorithm indicated by the value described in the first extension region (see (4-1) in FIG. 13), revocation check device 300 determines that the certificate conforms to the revocation rules. If otherwise, revocation check device 300 determines that the certificate does not conform to the revocation rules. In case (4), even if the signature algorithm of the certificate is not included in the CRL, the certificate is determined as invalid as a result of signature verification.

A specific example of the revocation determination processing will be described hereinafter. The following description is given assuming that the serial number of the certificate is “1A2B3C”, the signature algorithm of the certificate is “SECP256r1” that is a classical cryptography system, and revocation check device 300 supports PQC systems. It is also assumed that revocation check device 300 has extracted I={1A2B3C}, V1={SECP256r1}, and V2={PQC available} from the one or more extension regions in step S303 shown in FIG. 12.

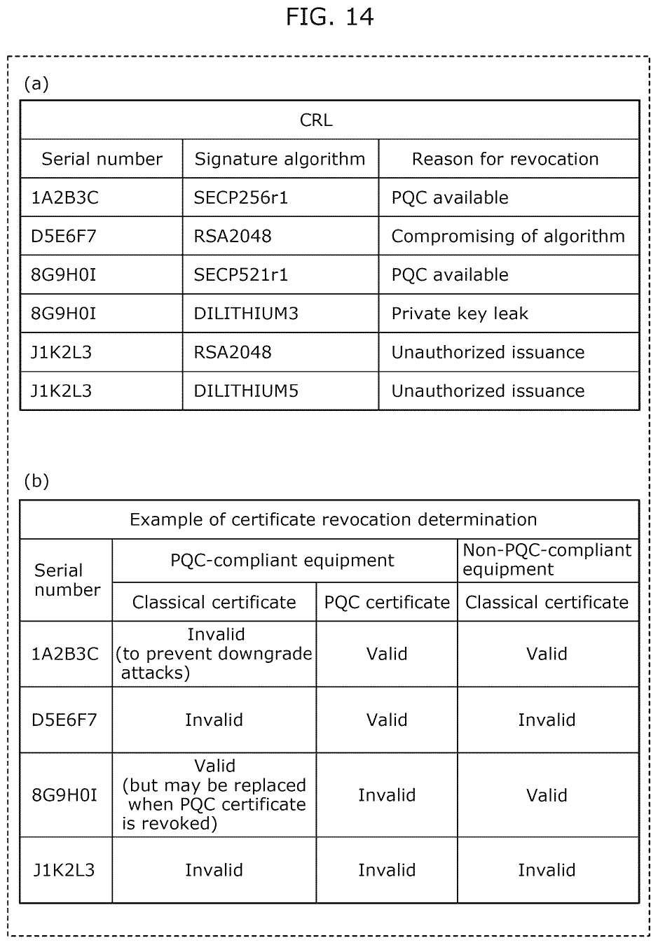

Firstly, since revocation check device 300 supports PQC systems and the signature algorithm of the certificate is the classical cryptography system, revocation check device 300 determines that the certificate applies to case (1) among the revocation rules. Then, since V1={SECP256r1} and signature algorithm A={SECP256r1}, revocation check device 300 determines that the certificate applies to (1-1) among the revocation rules. Then, since V2={PQC available}, revocation check device 300 determines that the certificate applies to (1-3) among the revocation rules. Accordingly, in this case, revocation check device 300 determines that the certificate is invalid. FIG. 14 is an explanatory drawing showing an example of determination made by the revocation n determination system (revocation check device 300) according to Embodiment 1. In FIG. 14, (a) shows one example of the information described in the CRL, and (b) shows an example of the determination made as to whether the certificate is valid or invalid in the revocation determination processing.

For example, in revocation check device 300 that supports PQC systems, the classical certificate whose serial number is “1A2B3C” is determined as invalid due to the reason for revocation that the PQC certificate is available, in order to prevent omission resulting from downgrading, but the PQC certificate is determined as valid. Revocation check device 300 that does not support PQC systems can recognize only the classical certificate, so that downgrading will not occur and the classical certificate is determined as valid.

Moreover, for example, in revocation check device 300 that supports PQC systems, a certificate whose serial number is “8G9H0I” and that uses a PQC cryptography system is determined as invalid due to the reason for revocation that the private key has been leaked. Meanwhile, the classical certificate that has been revoked due to the reason for revocation that the PQC certificate is available is made valid in order to replace the PQC certificate that has been revoked. Revocation check device 300 that does not support PQC systems can recognize only the classical certificate, so that downgrading will not occur and the classical certificate is determined as valid.

### 4. Advantages

Advantages of the revocation determination system (revocation determination method) according to Embodiment 1 will be described hereinafter. As described above, the revocation determination system according to Embodiment 1 identifies a certificate by not only referencing the serial number included in the CRL as in the revocation determination system according to the comparative example, but also referencing the one or more condition information items indicated in the one or more extension regions. Therefore, the revocation determination system according to Embodiment 1 has an advantage in that, even in the case where a plurality of certificates (in Embodiment 1, a multi-certificate) have a common serial number, it is possible to readily improve flexibility in determining whether the electronic certificate is valid or invalid, such as to revoke only one of the certificates.

The revocation determination system according to Embodiment 1 uses both of the signature algorithm of a certificate and the reason for revocation to determine whether the certificate is valid or invalid. Here, although the classical and PQC certificates are distinguishable by referencing only the signature algorithm, a case may arise in which, if only the signature algorithm is referenced, the classical certificate may not be revoked even though there is a reason for revoking the classical certificate. For example, in the case where the reason for revocation is compromising of the signature algorithm, the classical certificate needs to be revoked irrespective of whether the revocation check device supports PQC systems, but in the case where only the signature algorithm is referenced, the revocation check device that does not support PQC cryptography systems cannot revoke the classical certificate. In contrast, the revocation determination system according to Embodiment 1 uses both of the signature algorithm and the reason for revocation and therefore has an advantage of being capable of revoking the classical certificate even in such cases as described above.

### Embodiment 2

### 1. Configuration

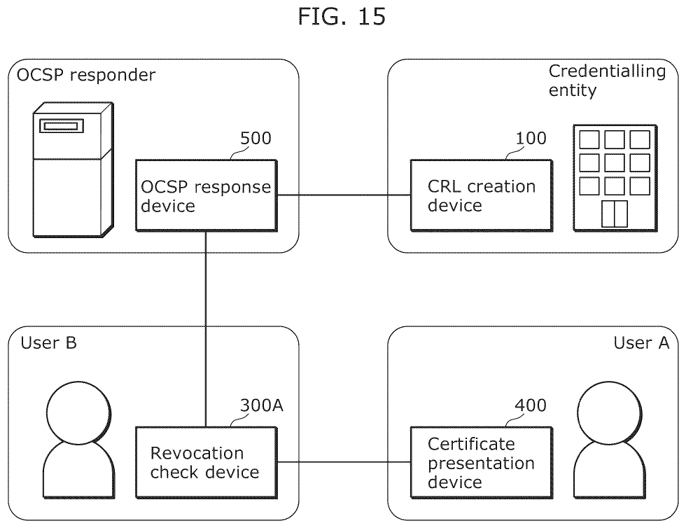

A revocation determination system (revocation determination method) according to Embodiment 2 will be described hereinafter. FIG. 15 is a block diagram showing one example of an overall configuration of the revocation determination system according to Embodiment 2. The revocation determination system according to Embodiment 2 is different from the revocation determination system according to Embodiment 1 in that it corresponds not to revocation check device 300A managed and operated by user B but to an online certificate status protocol (OCSP) response device 500 serving as an OCSP responder. The revocation determination system according to Embodiment 2 is also different from the revocation determination system according to Embodiment 1 in that CRL presentation device 200 is not managed and operated by a credentialling entity, and the functions of CRL presentation device 200 are integrated with OCSP response device 500. The following description will omit description of points that are common with the revocation determination system according to Embodiment 1.

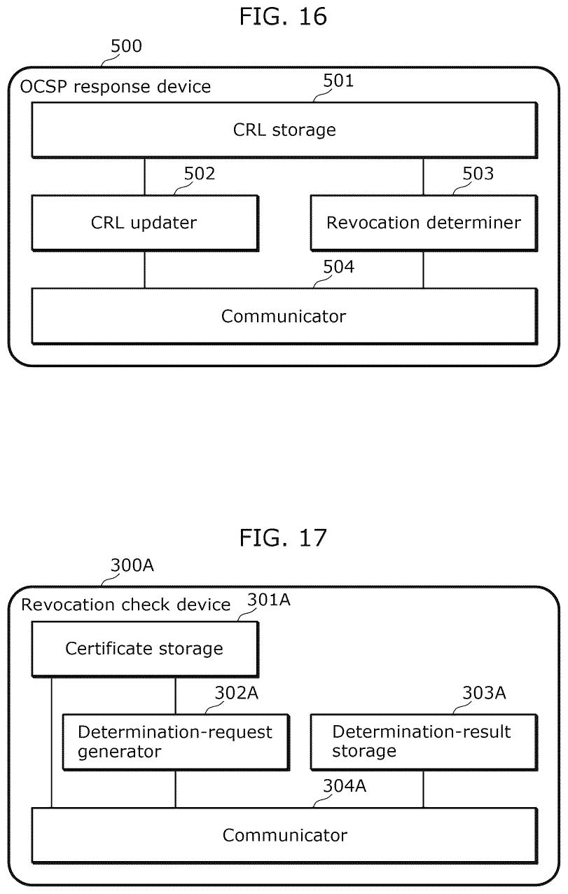

FIG. 16 is a block diagram showing one example of a functional configuration of OCSP response device 500 according to Embodiment 2. In Embodiment 2, OCSP response device 500 is realized by, for example, a server device. OCSP response device 500 stores CRL information generated by CRL creation device 100. Upon receiving a certificate and a determination request from revocation check device 300A, OCSP response device 500 determines whether the certificate is valid or invalid, and transmits the result of the determination to revocation check device 300A.

OCSP response device 500 includes a processor and memory and achieves its function by the processor executing a program stored in the memory. As shown in FIG. 16, OCSP response device 500 includes CRL storage 501, CRL updater 502, revocation determiner 503, and communicator 504.

CRL storage 501 stores CRL information received from CRL creation device 100 by communicator 504. CRL storage 501 also stores CRL information updated by CRL updater 502. As the CRL information, CRL storage 501 may store a CRL or may store CRL update information.

When communicator 504 has received CRL update information from CRL creation device 100, CRL updater 502 stores the CRL update information as the CRL information in CRL storage 501. Alternatively, CRL updater 502 may read out the CRL from CRL storage 501, update part or the whole of the readout CRL in accordance with the CRL update information, and store the updated CRL as the CRL information in CRL storage 501.

When communicator 504 has received a certificate and a determination request from revocation check device 300A, revocation determiner 503 performs revocation determination processing. Revocation determiner 503 corresponds to the determiner in the revocation determination system. The revocation determination processing is the same as the revocation determination processing described in Embodiment 1, and therefore description thereof shall be omitted.

Communicator 504 receives a certificate from revocation check device 300A. Communicator 504 corresponds to the first acquirer in the revocation determination system. Communicator 504 also receives CRL information from CRL creation device 100. Communicator 504 corresponds to the second acquirer in the revocation determination system. Communicator 504 further transmits, to revocation check device 300A, the result of determination obtained by the revocation determination processing performed by revocation determiner 503.

FIG. 17 is a block diagram showing one example of a functional configuration of revocation check device 300A according to Embodiment 2. Upon receiving a certificate from certificate presentation device 400, revocation check device 300A transmits the received certificate and a determination request to OCSP response device 500. Revocation check device 300A also receives the result of determination from OCSP response device 500.

Revocation check device 300A includes a processor and memory and achieves its function by the processor executing a program stored in the memory. As shown in FIG. 17, revocation check device 300A includes certificate storage 301A, determination request generator 302A, determination result storage 303A, and communicator 304A.

Certificate storage 301A stores a certificate received from certificate presentation device 400 by communicator 304A.

When communicator 304A has received a certificate from certificate presentation device 400, determination request generator 302A generates a determination request.

When communicator 304A has received the result of determination from OCSP response device 500, determination result storage 303A stores the received result of determination.

Communicator 304A receives a certificate from certificate presentation device 400. Communicator 304A also transmits the received certificate and a determination request generated by determination request generator 302A to OCSP response device 500. Communicator 304A further receives the result of determination from OCSP response device 500.

### 2. Operations

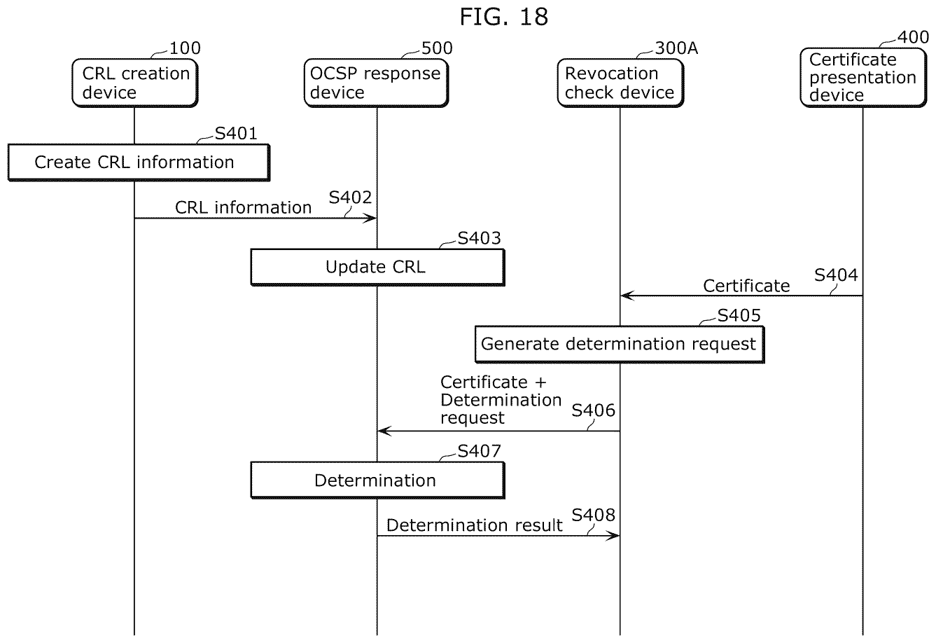

An example of operations of the overall configuration including the revocation determination system according to Embodiment 2 will be described hereinafter. FIG. 18 is a sequence diagram showing an example of the operations of the overall configuration including the revocation determination system according to Embodiment 2. The following description is given assuming that a credentialling entity has issued a certificate to user A, and certificate presentation device 400 has stored this certificate. In the following description, it is also assumed that a CRL has been updated after insurance of the certificate.

Firstly, CRL creation device 100 analyzes information about invalid certificates input by the credentialling entity and generates CRL information (S401). Then, CRL creation device 100 transmits the generated CRL information to OCSP response device 500 (S402). Upon receiving the CRL information, OCSP response device 500 updates the stored CRL (S403). In this way, the latest CRL is stored in OCSP response device 500.

Next, when communication is carried out between user A and another user (here, user B), user A transmits the stored certificate to the information terminal (here, revocation check device 300A) of the other user (S404). Upon receiving the certificate, revocation check device 300A generates a determination request (S405). Then, revocation check device 300A transmits the received certificate and the generated determination request to OCSP response device 500 (S406).

Upon receiving the certificate and the determination request, OCSP response device 500 determines whether the received certificate is valid or invalid, by using the latest CRL (S407). Then, OCSP response device 500 transmits the result of the determination to revocation check device 300A (S408).

As described above, in the revocation determination system according to Embodiment 2, OCSP response device 500 that is a server device locally performs the revocation determination processing, unlike in Embodiment 1 in which revocation check device 300 locally performs the revocation determination processing In this way, the revocation determination system according to Embodiment 2 is different in the entity of performing the revocation determination processing from the revocation determination system according to Embodiment 1, but has the same advantages as those achieved by the revocation determination system according to Embodiment 1.

### Other Embodiments

While Embodiments 1 and 2 have been described thus far, the present disclosure is not intended to be limited to Embodiments 1 and 2 described above.

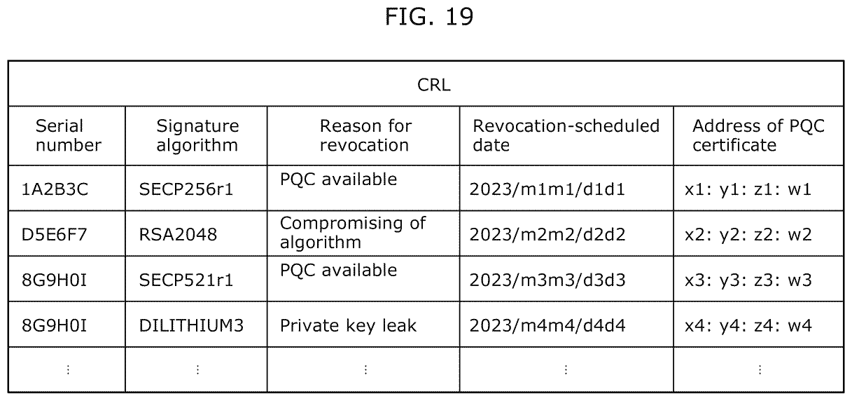

In Embodiments 1 and 2 described above, the one or more condition information items indicated in the one or more extension regions include the signature algorithm of a certificate and the reason for revocation, but the present disclosure is not limited thereto. For example, the one or more condition information items may include information item that indicate other conditions. FIG. 19 is a diagram showing one example of the one or more extension regions included in the certificate revocation list (CRL). As shown in FIG. 19, the one or more condition information items may further include the revocation-scheduled date of a certificate and the address of a PQC certificate.

In the case of using the CRL shown in FIG. 19, for example, the following measures may be taken for a certificate whose serial number is “1A2B3C” and whose signature algorithm is “SECP256r1” that is a classical cryptography system. That is, the certificate is supposed to be revoked due to the reason for revocation that the PQC certificate is available, but does not need to be revoked immediately because the reason for revocation is associated with the transition from the classical cryptography systems to the PQC systems. In such a case, by referencing “Revocation-scheduled date” as the condition information item, it is possible to provide some grace period (in other words, a period of notification) until the certificate is revoked. Moreover, by referencing “Address of PQC certificate” as the condition information item, it is possible to acquire the PQC certificate that is paired with the classical certificate, during the brace period.

In Embodiments 1 and 2 described above, the number of condition information items indicated in extension regions may be one. For example, either the signature algorithm or the reason for revocation may be described in an extension region.

In Embodiments 1 and 2 described above, certificates are not limited to classical certificates and PQC certificates, and may be any other certificate using a different cryptography system.

In Embodiments 1 and 2 described above, processing executed by a specific processing unit may be performed by a different processing unit. A sequence of a plurality of process steps may be changed, or a plurality of process steps may be performed in parallel.

In Embodiments 1 and 2 described above, each constituent element may be realized by executing a software program suitable for the constituent element. Each constituent element may also be realized by a program executor such as a central processing unit (CPU) or a processor that reads out and executes a software program recorded on a recording medium such as a hard disk or semiconductor memory.

Each constituent element may also be realized by hardware. For example, each constituent element may be a circuit (or an integrated circuit). These circuits may be integrated into a single circuit, or may be different circuits. These circuits may be general-purpose circuits, or may be dedicated circuits.

Note that general or specific aspects of the present disclosure may be realized as devices, methods, integrated circuits, computer programs, or recording media such as computer-readable CD-ROMs. The general or specific aspects of the present disclosure may also be realized by any combination of a device, a method, an integrated circuit, a computer program, and a recording medium.

For example, the present disclosure may be realized as a revocation determination method executed by a computer, or may be realized as a program for causing a computer to execute the revocation determination method. The present disclosure may also be realized as a non-transitory computer-readable recording medium having such a program recorded thereon.

For example, the present disclosure may be realized as a certificate-revocation-list creation method that is executed by a computer, or may be realized as a program for causing a computer to execute the certificate-revocation-list creation method. The present disclosure may also be realized as a non-transitory computer-readable recording medium that has recorded thereon such a program.

The present disclosure also includes other embodiments such as those obtained by applying various modifications conceivable by those skilled in the art to each embodiment and those achieved by arbitrarily combining constituent elements and functions described in each embodiment without departing from the scope of the present disclosure.

### INDUSTRIAL APPLICABILITY

The present disclosure is useful for determining whether an electronic certificate is valid or invalid.

1. A revocation determination method comprising:
acquiring an electronic certificate;
acquiring a certificate revocation list including one or more invalid certificates that are revoked electronic certificates; and
determining, based on a serial number and one or more condition information items, whether the electronic certificate acquired is valid or invalid, the serial number being included in the certificate revocation list acquired, the one or more condition information items being indicated in one or more extension regions included in the certificate revocation list acquired.

2. The revocation determination method according to claim 1,
wherein the one or more extension regions contain information indicating a signature algorithm targeted for revocation, and
the electronic certificate is determined as invalid when the serial number of the electronic certificate is included in the certificate revocation list and a signature algorithm of the electronic certificate matches the signature algorithm targeted for revocation.

3. The revocation determination method according to claim 1,
wherein the one or more extension regions contain information indicating a reason for revocation, and
the electronic certificate is determined as invalid when the serial number of the electronic certificate is included in the certificate revocation list and the electronic certificate corresponds to the reason for revocation.

4. The revocation determination method according to claim 1,
wherein the electronic certificate is a certificate using a classical cryptography system or a certificate using a post-quantum cryptography system.

5. The revocation determination method according to claim 4,
wherein whether a device that checks whether the electronic certificate is valid or invalid supports the post-quantum cryptography system is further referenced to determine whether the electronic certificate is valid or invalid.

6. A non-transitory computer-readable recording medium having recorded thereon a program for causing one or more processors to execute the revocation determination method according to claim 1.

7. A revocation determination system comprising:
a first acquirer that acquires an electronic certificate;
a second acquirer that acquires a certificate revocation list including one or more invalid certificates that are revoked electronic certificates; and
a determiner that determines, based on a serial number and one or more condition information items, whether the electronic certificate acquired by the first acquirer is valid or invalid, the serial number being included in the certificate revocation list acquired by the second acquirer, the one or more condition information items being indicated in one or more extension regions included in the certificate revocation list acquired by the second acquirer.

8. A certificate-revocation-list creation method comprising:
acquiring one or more serial numbers of one or more invalid certificates that are revoked electronic certificates;
acquiring one or more condition information items that indicate conditions for revocation and correspond respectively to one or more extension regions included in a certificate revocation list including the one or more invalid certificates; and
creating the certificate revocation list by describing the one or more serial numbers acquired respectively in one or more serial number regions included in the certificate revocation list and describing the one or more condition information items acquired respectively in the one or more extension regions included in the certificate revocation list.

9. A non-transitory computer-readable recording medium having recorded thereon a program for causing one or more processors to execute the certificate-revocation-list creation method according to claim 8.

10. A certificate-revocation-list creation system comprising:
a third acquirer that acquires one or more serial numbers of one or more invalid certificates that are revoked electronic certificates;
a fourth acquirer that acquires one or more condition information items that indicate conditions for revocation and correspond respectively to one or more extension regions included in a certificate revocation list including the one or more invalid certificates; and
a creation controller that creates the certificate revocation list by describing the one or more serial numbers acquired by the third acquirer respectively in one or more serial number regions included in the certificate revocation list and describing the one or more condition information items acquired by the fourth acquirer respectively in the one or more extension regions included in the certificate revocation list.
